(19) United States
(12) Patent Application Publication
(10) Pub. No.: US 2024/0364175 A1
(43) Pub. Date: Oct. 31, 2024

(54) MOTOR

(71) Applicant: KANZAKI KOKYUKOKI MFG. CO., LTD., Hyogo (JP)

(72) Inventor: Tatsuya KAMADA, Hyogo (JP)

(21) Appl. No.: 18/643,318

(22) Filed: Apr. 23, 2024

(30) Foreign Application Priority Data
Apr. 28, 2023 (JP) 2023-074863

(51) Int. Cl. H02K 5/04; H02K 1/14; H02K 21/16

(52) U.S. Cl. CPC H02K 5/04; H02K 1/146; H02K 21/16

(57) ABSTRACT

[Problem] To provide a motor capable of restricting relative rotation of a stator without reducing a magnetic field of the stator or increasing the number of components. [Solution] The motor 1 includes a rotor 2 rotatable about a rotary shaft 10, a stator 3 disposed radially outward of the rotor 2, and a housing 4 that houses the rotor 2 and the stator 3. The stator 3 is press-fitted to an inner peripheral surface of the housing 4. The motor has a stator core 20 provided to surround the rotor 2 and a coil 21 wound around the stator core 20. The stator core 20 has an engaging portion 23 protruding radially outward from an outer peripheral surface. The housing 4 has an engaged portion 32 that is recessed radially outward from the inner peripheral surface and with which the engaging portion 23 engages.

### CROSS REFERENCE TO RELATED APPLICATIONS

The present invention claims priority under 35 U.S.C. § 119 to Japanese Application No. 2023-074863, filed on Apr. 28, 2023, the entire contents of which being incorporated herein by reference.

### TECHNICAL FIELD

The present invention relates to a motor.

### BACKGROUND ART

The motor includes a rotatable rotor and a stator disposed radially outside the rotor. The rotor and the stator are housed in a housing. In this case, the stator needs to be fixed to the housing in order to keep a fixed position with respect to the rotation of the rotor. Therefore, in the conventional motor, concave portions are provided on the outer peripheral surface of the stator and the inner peripheral surface of the housing, and these concave portions are made opposed to each other. An engagement member such as a key is engaged with these concave portions to restrict the relative rotation of the stator with respect to the housing.

For example, according to a stator member disclosed in Patent Document 1, a housing-side key groove recessed radially outward is provided on an inner peripheral surface of a cylindrical portion of a motor housing. A core-side key groove recessed radially inward is provided on an outer peripheral surface of the stator core. A key member is provided that is fitted into the housing-side key groove and the core-side key groove to restrict the mutual relative rotation.

Further, in the motor disclosed in Patent Document 2, a stator is provided that has an inner peripheral surface opposed to an outer peripheral surface of a rotor, on which a permanent magnet is fitted, with a predetermined distance therebetween. Further, the outer peripheral surface of the stator is press-fitted as a press-fitting surface and fixed to a motor case. A plurality of projections are formed on the inner peripheral surface of the motor case, and concave portions to be engaged with the projections are formed on the outer peripheral surface of the stator. When the stator is press-fitted into the motor case, the inner bottom surface of the concave portion of the stator is press-fitted as a press-fitting surface and fixed to the motor case. When the projection of the motor case is engaged with the concave portion of the stator, relative rotation of the stator with respect to the motor case is restricted.

### PRIOR ART DOCUMENT

### Patent Document

Patent Document 1: Japanese Unexamined Patent Application Publication No. 2021-052454
Patent Document 2: Japanese Unexamined Patent Application Publication No. 2008-067571

### SUMMARY OF INVENTION

### Technical Problem

In a conventional motor, an engaging member such as a key or a convex portion provided on a housing is engaged with a concave portion provided on a stator to restrict relative rotation of the stator with respect to the housing. However, for this reason, the magnetic field generated in the stator is reduced by providing the concave portion in the stator. Further, when an engaging member such as a key is provided, the number of components increases, the number of assembling steps increases, and the cost increases.

An object of the present invention is to provide a motor capable of restricting relative rotation of a stator without reducing a magnetic field of the stator or increasing the number of components.

### Solution to Problem

In order to solve the above problem, a motor of the present invention includes a rotor rotatable about a rotary shaft, a stator disposed radially outward of the rotor, and a housing that houses the rotor and the stator. The stator has a stator core press-fitted to an inner peripheral surface of the housing and provided to surround the rotor, and a coil wound around the stator core. The stator core has an engaging portion protruding radially outward from an outer peripheral surface. The housing is characterized by having an engaged portion that is recessed radially outward from the inner peripheral surface and with which the engaging portion engages.

### Advantageous Effects of Invention

According to the present invention, there is provided a motor capable of restricting relative rotation of a stator without reducing a magnetic field of the stator or increasing the number of components.

### BRIEF DESCRIPTION OF DRAWINGS

FIG. 1 is an exploded perspective view showing a motor according to an embodiment of the present invention.

FIG. 2 is a side cross-sectional view showing the motor according to the embodiment of the present invention.

FIG. 3 is a cross-sectional view along A-A in FIG. 2.

FIG. 4 is an enlarged cross-sectional view showing an engaging portion and an engaged portion and periphery thereof of the motor according to the embodiment of the present invention.

FIG. 5 is an enlarged view of a portion B in FIG. 2.

### DESCRIPTION OF EMBODIMENTS

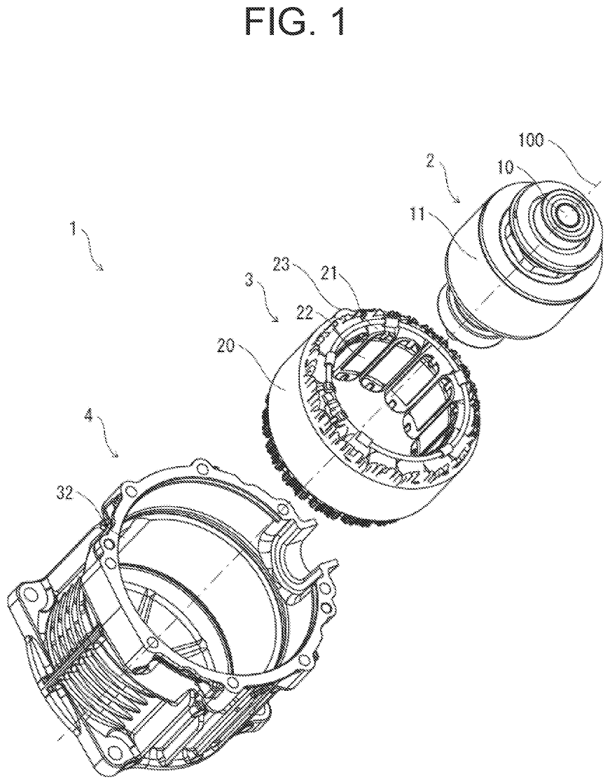

A motor 1 according to an embodiment of the present invention is described with reference to the drawings. As shown in FIGS. 1, 2, and 3, the motor 1 includes a rotor 2, a stator 3, and a housing 4. The rotor 2, the stator 3, and the housing 4 are provided coaxially with the central axis 100.

The rotor 2 includes a rotary shaft 10, a rotor core 11, and a plurality of permanent magnets 12, and is configured to be rotatable about the rotary shaft 10.

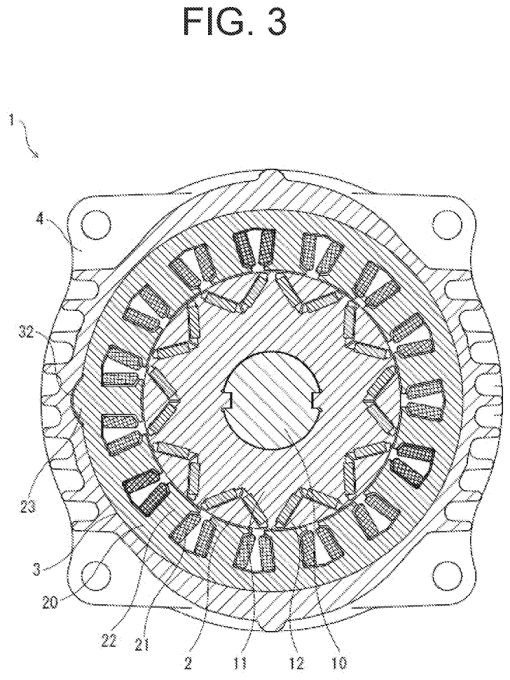

The rotary shaft 10 is formed to have a columnar shape extending along a predetermined central axis 100 and is provided rotatably around the central axis. The rotor core 11 is formed to have a cylindrical shape and has an inner space at the center in a radial direction. The rotor core 11 is coaxially fixed to the rotary shaft 10 by press-fitting the rotary shaft 10 into the inner space of the rotor core 11. As shown in FIG. 3, the plurality of permanent magnets 12 are arranged at equal intervals in a circumferential direction of the rotor core 11 and are fixed to the rotor core 11.

The stator 3 includes a stator core 20 and a plurality of coils 21 and is disposed radially outside the rotor 2.

The stator core 20 is formed to have a cylindrical shape and has a plurality of teeth 22 protruding radially inward. The stator core 20 has an inner space at the center in the radial direction (inside the plurality of teeth 22). The stator core 20 is disposed inside the housing 4 and is press-fitted to an inner peripheral surface of the housing 4 by shrink fitting or the like. The rotor 2 is disposed in the inner space of the stator core 20 so that the stator core 20 is coaxial with the rotor 2. In other words, the stator core 20 is provided so as to surround the rotor 2. The plurality of teeth 22 are arranged at equal intervals in the circumferential direction of the stator core 20. Each coil 21 is wound around each tooth 22.

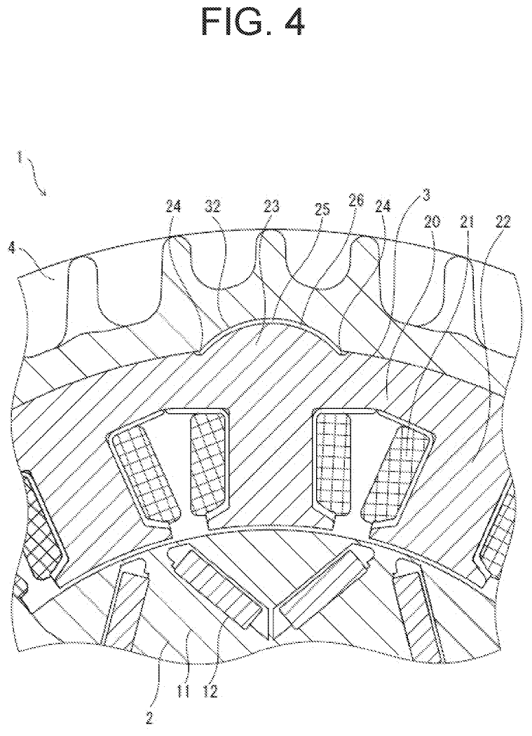

In the present embodiment, as shown in FIG. 4 in particular, the stator core 20 has an engaging portion 23 protruding radially outward from an outer peripheral surface. The engaging portion 23 is formed so that the projection height from the outer peripheral surface of the stator core 20 to the radially outer side is the same height along the axial direction. For example, the engaging portion 23 bulges outward in the radial direction and has a shape in which a cross section in the radial direction is curved outward in the radial direction. The stator core 20 preferably has concave portions 24 that are recessed inward in the radial direction at both ends of the engaging portion 23 in the circumferential direction.

The outer peripheral surface of the stator core 20 other than the engaging portion 23 is press-fitted to the inner peripheral surface of the housing 4. As shown in FIG. 4, a gap 25 serving as a cooling portion (heat dissipating portion) for cooling (dissipating heat from) the motor 1 is formed between the engaging portion 23 and the inner peripheral surface (engaged portion 32) of the housing 4. A heat conductive material 26 such as heat dissipating grease is applied to a side surface of the engaging portion 23 opposed to the inner peripheral surface of the housing 4.

The housing 4 is formed to have a bottomed cylindrical shape with one end opened, and coaxially houses the rotor 2 and the stator 3. The stator 3 (stator core 20) is press-fitted to the inner peripheral surface of the housing 4 in a state in which the rotor 2 is disposed inside the stator 3. Here, one end of the stator 3 in the axial direction is disposed on the opening side (one end side) of the housing 4, and the other end of the stator 3 is in contact with a step portion 4a of the housing 4. The step portion 4a is in contact with a lower surface of the outer peripheral edge of the stator 3 (engaging portion 23) to prevent the stator 3 from moving in the axial direction (downward in the drawing). The step portion 4a closes a space (gap 25) between the engaged portion 32 and the engaging portion 23 on the lower side. For example, the housing 4 has an inner diameter slightly smaller than the outer diameter of the stator 3 (stator core 20). By enclosing the stator 3 in the heated and expanded housing 4, the stator 3 is press-fitted into the housing 4 by shrink fitting.

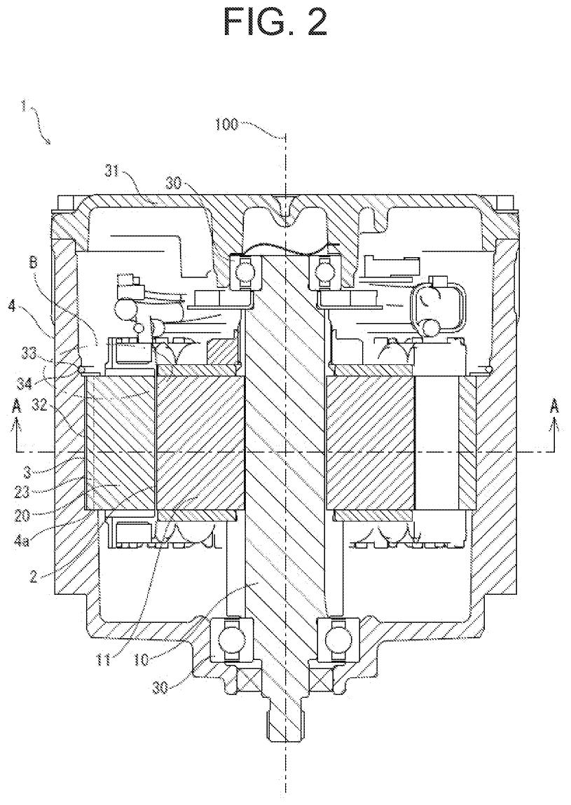

As shown in FIG. 2, the housing 4 has bearings 30 on both ends in the axial direction of the rotor 2, and the rotary shaft 10 of the rotor 2 is supported by these bearings 30. Thus, the rotor 2 is rotatably disposed with respect to the housing 4. The bearing 30 on the opening side of the housing 4 may be provided on a lid portion 31 that closes the opening of the housing 4.

In the present embodiment, in particular, the housing 4 includes the engaged portion 32 that is recessed radially outward from the inner peripheral surface and with which the engaging portion 23 of the stator 3 (stator core 20) engages. The engaged portion 32 has a shape corresponding to the engaging portion 23. The depth of the engaged portion 32 recessed outward in the radial direction from the inner peripheral surface of the housing 4 is the same depth along the axial direction. For example, similarly to the engaging portion 23, the engaged portion 32 has a shape in which a cross section in the radial direction is curved outward in the radial direction.

The stator 3 (stator core 20) is press-fitted into the housing 4 in a state in which the engaging portion 23 and the engaged portion 32 are positioned at the same position in the circumferential direction. The engaging portion 23 and the engaged portion 32 are preferably positioned so that the concave portions 24 at both ends of the engaging portion 23 correspond to edge portions at both ends of the engaged portion 32 in the circumferential direction. The engaging portion 23 and the engaged portion 32 are formed to have a predetermined gap 25 between the engaging portion 23 and the engaged portion 32 when the stator core 20 is press-fitted into the housing 4.

As a result, the gap 25 between the engaging portion 23 and the engaged portion 32 is filled with the heat conductive material 26 (specifically, heat dissipating grease as an example) applied to the side surface of the engaging portion 23. The gap 25 between the engaging portion 23 and the engaged portion 32 and the heat conductive material 26 constitute a cooling portion (heat dissipating portion) that cools (dissipates heat from) the motor 1. A radial distance of the gap 25 between the engaging portion 23 and the engaged portion 32 is set to be constant along the circumferential direction.

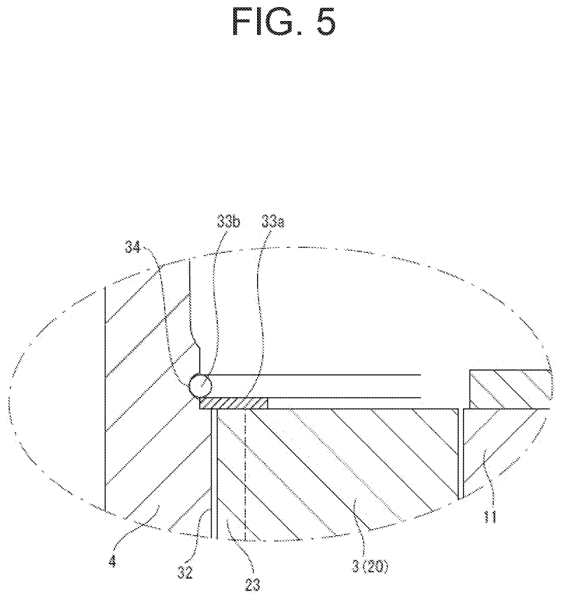

Further, as shown in FIGS. 2 and 5, the housing 4 has a retaining member 33 for retaining the stator 3. The retaining member 33 is fixed to the inner peripheral surface of the housing 4 in a state in which the retaining member 33 is in contact with (in close contact with) one end of the stator 3 (the stator core 20) in the axial direction. The retaining member 33 is, for example, formed of an annular retaining ring or the like made of a material such as steel having an outer diameter larger than the inner diameter of the housing 4. The retaining member 33 is fitted into a groove portion 34 provided on the inner peripheral surface of the housing 4 and is in contact with one end of the stator 3 along the circumferential direction. The retaining member 33 liquid-tightly closes the gap 25 between the engaging portion 23 and the engaged portion 32 from the opening side of the housing 4 in the axial direction. To be more specific, as shown in FIG. 5, the retaining member 33 includes a first retaining member 33a and a second retaining member 33b. The first retaining member 33a has an annular plate shape and is in contact with the housing 4 and the upper surface of the outer peripheral edge of the stator 3 (the engaging portion 23) so as to straddle them, thereby closing the space (the gap 25) between the engaged portion 32 and the engaging portion 23 on the upper side. The second retaining member 33b is an elastic C-shaped retaining ring, is engaged with the groove portion 34, and comes into contact with the back surface of the first retaining member 33a to prevent the stator 3 from moving in the axial direction (upward in the drawing) together with the first retaining member 33a.

As described above, according to the present embodiment, the motor 1 includes the rotor 2 rotatable about the rotary shaft 10, the stator 3 disposed radially outward of the rotor 2, and the housing 4 that houses the rotor 2 and the stator 3. The stator 3 is press-fitted to the inner peripheral surface of the housing 4 and has the stator core 20 provided to surround the rotor 2 and the coil 21 wound around the stator core 20. The stator core 20 has the engaging portion 23 protruding radially outward from the outer circumferential surface. The housing 4 has the engaged portion 32 that is recessed radially outward from the inner peripheral surface and with which the engaging portion 23 engages.

Thus, in the motor 1, the relative rotation of the stator 3 with respect to the housing 4 can be restricted without providing an engagement member such as a key. Therefore, the number of components can be reduced, the number of assembling steps can be reduced, and the cost can be suppressed. In addition, since no concave portion is provided on the outer peripheral surface of the stator 3 (stator core 20), it is possible to suppress a reduction in the magnetic field generated in the stator 3. As described above, according to the present invention, it is possible to provide the motor 1 capable of restricting relative rotation of the stator 3 without reducing a magnetic field of the stator 3 or increasing the number of components.

Further, according to the present embodiment, the engaging portion 23 and the engaged portion 32 are formed to have the predetermined gap 25 therebetween, and the heat conductive material 26 is applied to the side surface of the engaging portion 23 opposed to the engaged portion 32.

Accordingly, in the motor 1, it is possible to configure the cooling portion (heat dissipating portion) that cools (dissipates heat from) the motor 1 by using the configuration for restricting the relative rotation of the stator 3 with respect to the housing 4. Therefore, the cooling efficiency (heat dissipating efficiency) of the motor 1 can be improved without increasing the number of components or increasing the cost.

Further, according to the present embodiment, the housing 4 further includes the retaining member 33 that is in contact with the end portion of the stator core 20 in the axial direction and is fixed to the housing 4.

Accordingly, in the motor 1, it is possible to suppress a risk that the stator 3 is detached from the housing 4 during operation. Leakage of the heat conductive material 26 can be suppressed by using the retaining member 33, and safety can be improved.

Further, according to the present embodiment, the stator core 20 has the concave portions 24 recessed radially inward at both ends of the engaging portion 23 in the circumferential direction.

Thus, in the motor 1, when the stator 3 is incorporated into the housing 4, edge portions at both circumferential ends of the engaged portion 32 are positioned correspondingly to the concave portions 24. Such an edge portion can be prevented from interfering with the outer peripheral surface of the stator core 20, and the stator 3 can be smoothly assembled.

In the above-described embodiment, the stator core 20 has one engaging portion 23 in the circumferential direction. Corresponding to this, an example in which the housing 4 has one engaged portion 32 in the circumferential direction has been described, but the present invention is not limited to this example.

As another example, the stator core 20 has a plurality of (at least two) engaging portions 23 in the circumferential direction. Corresponding to this, the housing 4 may have a plurality of (at least two) engaged portions 32 in the circumferential direction. In this case, the plurality of engaging portions 23 are arranged at equal intervals in the circumferential direction. The plurality of engaged portions 32 are arranged at equal intervals in the circumferential direction so as to correspond to the plurality of engaging portions 23, respectively.

A predetermined gap 25 is provided between each corresponding engaging portion 23 and each corresponding engaged portion 32. A heat conductive material 26 is applied to a side surface of each engaging portion 23 opposed to each engaged portion 32, thereby a plurality of cooling portions (heat dissipating portions) are formed in the circumferential direction. The area for cooling (dissipating heat from) the motor 1 can be made relatively large, and the cooling efficiency can be improved. By making the length of each engaging portion 23 in the circumferential direction relatively short, the area of the outer peripheral surface of the stator core 20 press-fitted to the inner peripheral surface of the housing 4 can be made relatively large. Adhesion between the stator 3 and the housing 4 can be enhanced.

In the above-described embodiment, the engaging portion 23 bulges outward in the radial direction and has a shape in which a cross section in the radial direction is curved outward in the radial direction. An example in which the engaged portion 32 is recessed so that the radial cross section is curved radially outward has been described. However, the present invention is not limited to this example.

As another example, the engaging portion 23 may be formed so that the cross section in the radial direction protrudes radially outward in another shape such as a rectangular shape. Corresponding to the engaging portion 23, the engaged portion 32 may be recessed so that a cross section in the radial direction recessed radially outward in another shape such as a rectangular shape.

Furthermore, in the above-described embodiment, an example in which the retaining member 33 is formed of an annular retaining ring made of steel has been described, but the present invention is not limited to this example. As another example, the retaining member 33 is formed in a two-layer structure of an annular retaining ring made of steel and a seal member. The seal member may be brought into contact (close contact) with one end of the stator 3 (stator core 20).

In the above-described embodiment, an example in which the retaining member 33 is fixed to the housing 4 by being fitted into the groove portion 34 of the inner peripheral surface of the housing 4 has been described. However, the present invention is not limited to this example. As another example, the retaining member 33 may be fixed to the housing 4 by a fastening member such as a screw.

In the above-described embodiment, an example in which the rotor 2 includes the plurality of permanent magnets 12 is described. However, the present invention is not limited to this example. As another example, the rotor 2 may be configured by an induction motor, a reluctance motor, or the like.

Note that the present invention can be appropriately changed without departing from an outline and an idea of the invention that can be read from the claims and the entire specification. A motor with such a change is also included in the technical idea of the present invention.

### [Supplementary Note of the Invention]

Hereinafter, an outline of the invention extracted from the above-described embodiment will be supplementary described. Note that the configurations and processing functions described in the following supplementary notes can be selected and arbitrarily combined.

### <Supplementary Note 1>

A motor is characterized by having: a rotor rotatable about a rotary shaft; a stator disposed radially outward of the rotor; and a housing that houses the rotor and the stator, where the stator has a stator core press-fitted to an inner peripheral surface of the housing and provided to surround the rotor, and a coil wound around the stator core, the stator core has an engaging portion protruding radially outward from an outer peripheral surface, and the housing has an engaged portion that is recessed radially outward from the inner peripheral surface and with which the engaging portion engages.

### <Supplementary Note 2>

The engaging portion and the engaged portion are formed to have a predetermined gap therebetween. The motor according to Supplementary Note 1 is characterized in that a heat conductive material is applied to a side surface of the engaging portion opposed to the engaged portion.

### <Supplementary Note 3>

The motor according to Supplementary Note 1 or 2 is characterized by further including a retaining member that is in contact with an axial end portion of the stator core and is fixed to the housing.

### <Supplementary Note 4>

The motor according to any one of Supplementary Notes 1 to 3 characterized in that the stator core has concave portions recessed radially inward at both ends of the engaging portion in a circumferential direction.

### REFERENCE SIGNS LIST

1 motor
2 rotor
3 stator
4 housing
10 rotary shaft
20 stator core
21 coil
23 engaging portion
24 concave portion
25 gap
26 heat conductive material
32 engaged portion
33 retaining member

1. A motor comprising:
a rotor rotatable about a rotary shaft;
a stator disposed radially outward of the rotor; and
a housing that houses the rotor and the stator, wherein
the stator has a stator core press-fitted to an inner peripheral surface of the housing and provided to surround the rotor, and a coil wound around the stator core,
the stator core has an engaging portion protruding radially outward from an outer peripheral surface, and
the housing has an engaged portion that is recessed radially outward from the inner peripheral surface and with which the engaging portion engages.

2. The motor according to claim 1, wherein
the engaging portion and the engaged portion are formed to have a predetermined gap therebetween, and
a heat conductive material is applied to a side surface of the engaging portion opposed to the engaged portion.

3. The motor according to claim 1, further comprising
a retaining member that is in contact with an axial end portion of the stator core and is fixed to the housing.

4. The motor according to claim 1, wherein
the stator core has recessed portions recessed radially inward at both ends of the engaging portion in a circumferential direction.
